(19) United States
(12) Patent Application Publication
(10) Pub. No.: US 2021/0343128 A1
(43) Pub. Date: Nov. 4, 2021

(54) Weapon Detection Entry Assembly

(71) Applicant: Henry Payne, Ruleville, MS (US)

(72) Inventor: Henry Payne, Ruleville, MS (US)

(21) Appl. No.: 16/862,144

(22) Filed: Apr. 29, 2020

(51) Int. Cl. G08B 13/196; G08B 27/00

(52) U.S. Cl. CPC G08B 13/19645; G08B 27/001; G08B 13/19656

(57) ABSTRACT

A weapon detection entry assembly includes an entry way that is attached to a building to have people walk therethrough to enter the building. A plurality of door locks is each associated with a respective one of a plurality of doors in the building. Each of the door locks is actuatable into a locking condition for locking the doors. A weapon detector is integrated into the entry way to detect a weapon on the people walking through the entry way. Each of the door locks is actuated into the locking condition when the weapon detector detects a weapon. A transceiver is integrated into the building and the transceiver broadcasts an alert signal when the weapon detector detects a weapon to facilitate emergency responders to respond to a potential shooter emergency at the building.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to entry devices and more particularly pertains to a new entry device for detecting a weapon on a person trying to enter a building.

### (2) Description of Related Art Including Information Disclosed Under 37 CFR 1.97 and 1.98

The prior art relates to entry devices including an alert device for alerting emergency responders to a potential shooter emergency at a public school. The prior art discloses an alert device that includes a central processing facility for alerting emergency responders to a potential shooter emergency at a public school. The prior art discloses a hall monitoring system that includes a telephone system and a video surveillance system for notifying emergency responders of a potential shooter emergency at a public school. The prior art also discloses an alert device that includes cameras, door locks and an alert device for notifying emergency responders to a potential shooter emergency at a public school.

### BRIEF SUMMARY OF THE INVENTION

An embodiment of the disclosure meets the needs presented above by generally comprising an entry way that is attached to a building to have people walk therethrough to enter the building. A plurality of door locks is each associated with a respective one of a plurality of doors in the building. Each of the door locks is actuatable into a locking condition for locking the doors. A weapon detector is integrated into the entry way to detect a weapon on the people walking through the entry way. Each of the door locks is actuated into the locking condition when the weapon detector detects a weapon. A transceiver is integrated into the building and the transceiver broadcasts an alert signal when the weapon detector detects a weapon to facilitate emergency responders to respond to a potential shooter emergency at the building.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a weapon detection entry assembly according to an embodiment of the disclosure.

FIG. 2 is a perspective view of a control panel of an embodiment of the disclosure.

FIG. 3 is a schematic view of an embodiment of the disclosure.

### DETAILED DESCRIPTION OF THE INVENTION

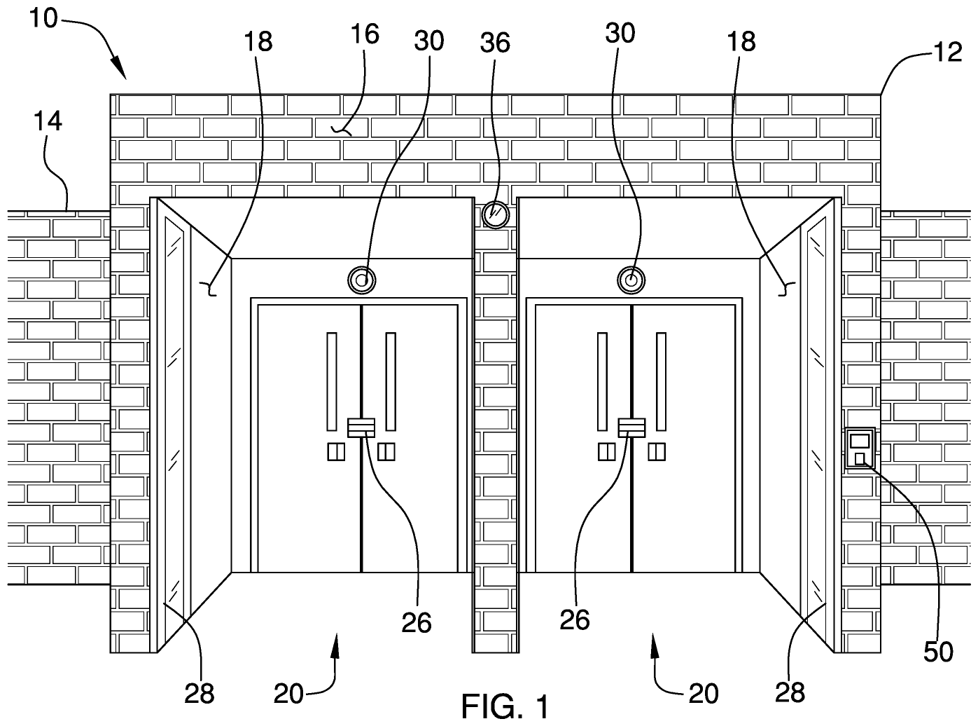

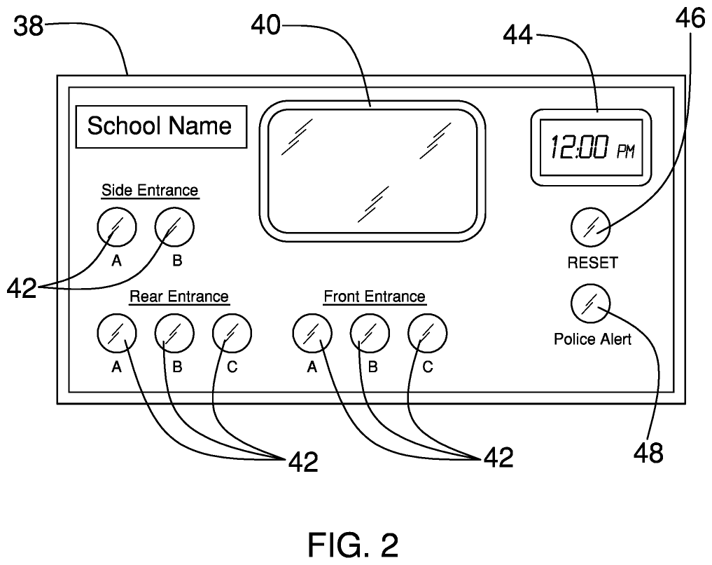

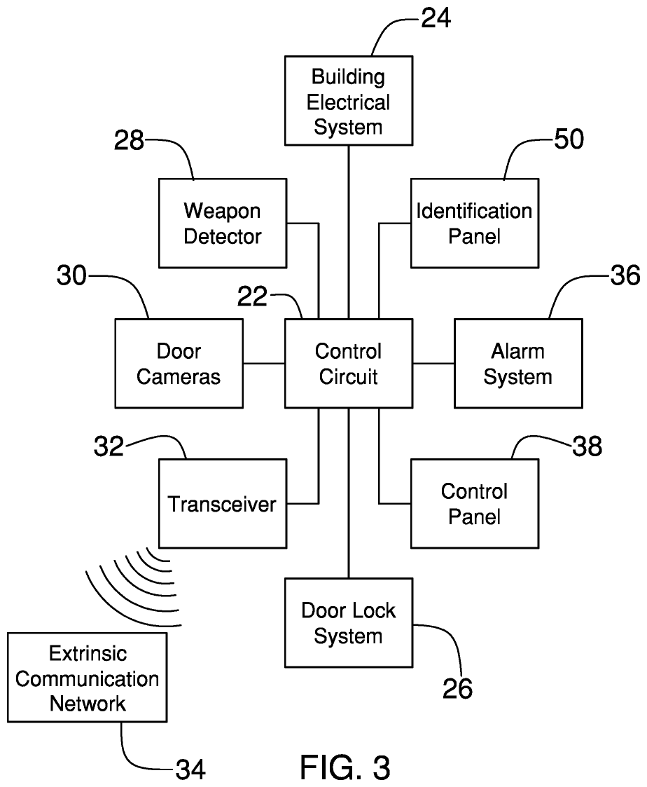

With reference now to the drawings, and in particular to FIGS. 1 through 3 thereof, a new entry device embodying the principles and concepts of an embodiment of the disclosure and generally designated by the reference numeral 10 will be described.

As best illustrated in FIGS. 1 through 3, the weapon detection entry assembly 10 generally comprises an entry way 12 is attached to a building 14 for having people walk therethrough to enter the building 14. The entry way 12 has a forward facing surface 16 and a bounding surface 18 defining a space 20 through which people can walk. Moreover, the entry way 12 may have a depth ranging between approximately 6.0 feet and 10.0 feet. The building 14 may be a public school or other similar public facility. Additionally, a plurality of the entry ways 12 may be provided and each of the plurality of entry ways 12 may be aligned with a respective front entrance, back entrance and side entrance of the building 14.

A control circuit 22 is integrated into the building 14 and the control circuit 22 receives an alert input. The control circuit 22 is electrically coupled to a power source 24 comprising an electrical system of the building 14. A plurality of door locks 26 is provided and each of the door locks 26 is positioned within the building 14. Each of the door locks 26 is associated with a respective one of a plurality of doors in the building 14. Each of the door locks 26 is actuatable into a locking condition for locking the doors and each of the door locks 26 is in a normally unlocked condition thereby unlocking the doors. Each of the door locks 26 is electrically coupled to the control circuit 22 and each of the door locks 26 is actuated into the locking condition when the control circuit 22 receives the alert input. Moreover, each of the door locks 26 may comprise an electronic door lock of any conventional design.

A weapon detector 28 is provided and the weapon detector 28 is integrated into the entry way 12 to detect a weapon on the people walking through the entry way 12. The weapon detector 28 is positioned on the bounding surface 18 of the space 20 thereby facilitating the weapon detector 28 to scan the people as the people walk through the space 20. Each of the door locks 26 is actuated into the locking condition when the weapon detector 28 detects a weapon to inhibit the person with the weapon from accessing occupants of the building 14. The weapon detector 28 is electrically coupled to the control circuit 22 and the control circuit 22 receives the alert input when the weapon detector 28 detects a weapon. The weapon detector 28 may include a metal detector, a body scanner or any other type of device that is capable of identifying a weapon on a person's body.

A plurality of cameras 30 is provided and each of the cameras 30 is coupled to the entry way 12 for capturing imagery of the people entering the building 14. Each of the cameras 30 is electrically coupled to the control circuit 22 and each of the cameras 30 may comprise a digital camera of any conventional design that can capture video and still images. A transceiver 32 is integrated into the building 14 and the transceiver 32 is in communication with an extrinsic communication network 34. In this way the transceiver 32 is in communication with emergency responders. The extrinsic communication network 34 may be the internet, a telephone communication network or any other similar type of non-local communication network. Additionally, the emergency responders may be local police or other agency contacted via 911.

The transceiver 32 broadcasts an alert signal when the weapon detector 28 detects a weapon. In this way the transceiver 32 facilitates the emergency responders to respond to a potential shooter emergency at the building 14. The transceiver 32 is electrically coupled to the control circuit 22 and the transceiver 32 broadcasts the alert signal when the control circuit 22 receives the alert input. Moreover, the transceiver 32 broadcasts the image captured by the cameras 30 pertaining to the person upon which the weapon was detected. In this way the transceiver 32 alerts the emergency responders to the identity of the person upon which the weapon was detected. An alarm 36 is positioned within the building 14 and the alarm 36 is electrically coupled to the control circuit 22. The alarm 36 emits an audible alert when the control circuit 22 receives the alert input to alert occupants of the building 14 that a weapon has been detected and that the doors of the building 14 will be locked.

A control panel 38 is provided and the control panel 38 is positioned within the building 14 such that the control panel 38 is visible to administrative staff in the building 14. The control panel 38 includes a display 40 that is electrically coupled to the control circuit 22 for displaying operational parameters of the control circuit 22. A plurality of light emitters 42 is each coupled to the control panel 38 and each of the light emitters 42 is electrically coupled to the control circuit 22. Each of the light emitters 42 is assigned to represent a respective one of the front entrance, the back entrance and the side entrance to the building 14. The appropriate one of the light emitters 42 is turned on to communicate at which location the weapon was detected. In this way the administrative staff can take appropriate counter measures to ensure the safety of the occupants of the building 14.

A clock 44 is positioned on the display 40, the clock 44 is electrically coupled to the control circuit 22 and the clock 44 displays the current time of day. A reset button 46 and a police alert button 48 are each movably coupled to the control panel 38 and each of the reset button 46 and the police alert button 48 are electrically coupled to the control circuit 22. The reset button 46 resets all of the door locks 26, the alarm 36, the transceiver 32, the cameras 30 and the alarm 36 when the reset button 46 is depressed. The police alert button 48 actuates the transceiver 32 to broadcast the alert signal to the emergency responders regardless of whether a weapon has been detected.

An identification panel 50 is attached to the entry way 12 and the identification panel 50 is electrically coupled to the control circuit 22. The identification panel 50 recognizes identification of the emergency responders when the emergency responders arrive at the building 14. The control circuit 22 facilitates the door associated with the entry way 12 to be unlocked thereby facilitating the emergency responders to access the building 14. The identification panel 50 may be an electronic card reader or any other type of electronic identification device that can recognize identification of emergency responders.

In use, each person that wishes to enter the building 14 passes through the entry way 12 to gain access to the building 14. In this way the weapon detector 28 can scan each person to detect whether each person is carrying a weapon. Each of the door locks 26 is actuated to lock the respective doors, the transceiver 32 broadcasts the alert signal and the alarm 36 emits the audible alert when the weapon detector 28 detects a weapon. In this way the person that is carrying the weapon is restricted from accessing the building 14 and the emergency responders are immediately notified for appropriate response.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weapon detection entry assembly for detecting a weapon on a person entering a building a subsequently locking the building down for security purposes, said assembly comprising:
an entry way being attached to a building wherein said entry way is configured to have people walk therethrough to enter the building;
a plurality of door locks, each of said door locks being positioned within the building, each of said door locks being associated with a respective one of a plurality of doors in the building, each of said door locks being actuatable into a locking condition for locking the doors, each of said door locks being in a normally unlocked condition thereby unlocking the doors;
a weapon detector being integrated into said entry way wherein said weapon detector is configured to detect a weapon on the people walking through said entry way, each of said door locks being actuated into said locking condition when said weapon detector detects a weapon wherein said plurality of door locks is configured to inhibit the person with the weapon from accessing occupants of the building;
a plurality of cameras, each of said cameras being coupled to said entry way wherein each of said cameras is configured to capture imagery of the people entering the building; and
a transceiver being integrated into the building, said transceiver being in communication with an extrinsic communication network wherein said transceiver is configured to be in communication with emergency responders, said transceiver broadcasting an alert signal when said weapon detector detects a weapon wherein said transceiver is configured to facilitate the emergency responders to respond to a potential shooter emergency at the building.

2. The assembly according to claim 1, wherein:
said entry way has a forward facing surface and a bounding surface defining a space through which people can walk; and
said weapon detector is positioned on said bounding surface of said space wherein said weapon detector is configured to scan the people as the people walk through said space.

3. The assembly according to claim 1, further comprising a control circuit being integrated into said building, said control circuit receiving an alert input, said control circuit being electrically coupled to a power source comprising an electrical system of the building.

4. The assembly according to claim 3, wherein each of said door locks being electrically coupled to said control circuit, each of said door locks being actuated into said locking condition when said control circuit receives said alert input.

5. The assembly according to claim 3, wherein said weapon detector is electrically coupled to said control circuit, said control circuit receiving said alert input when said weapon detector detects a weapon.

6. The assembly according to claim 3, wherein said transceiver is electrically coupled to said control circuit, said transceiver broadcasting said alert signal when said control circuit receives said alert input, said transceiver broadcasting the image captured by said cameras pertaining to the person upon which the weapon was detected wherein said transceiver is configured to alert the emergency responders to the identity of the person upon which the weapon was detected.

7. A weapon detection entry assembly for detecting a weapon on a person entering a building a subsequently locking the building down for security purposes, said assembly comprising:
an entry way being attached to a building wherein said entry way is configured to have people walk therethrough to enter the building, said entry way having a forward facing surface and a bounding surface defining a space through which people can walk;
a control circuit being integrated into said building, said control circuit receiving an alert input, said control circuit being electrically coupled to a power source comprising an electrical system of the building;
a plurality of door locks, each of said door locks being positioned within the building, each of said door locks being associated with a respective one of a plurality of doors in the building, each of said door locks being actuatable into a locking condition for locking the doors, each of said door locks being in a normally unlocked condition thereby unlocking the doors, each of said door locks being electrically coupled to said control circuit, each of said door locks being actuated into said locking condition when said control circuit receives said alert input;
a weapon detector being integrated into said entry way wherein said weapon detector is configured to detect a weapon on the people walking through said entry way, said weapon detector being positioned on said bounding surface of said space wherein said weapon detector is configured to scan the people as the people walk through said space, each of said door locks being actuated into said locking condition when said weapon detector detects a weapon wherein said plurality of door locks is configured to inhibit the person with the weapon from accessing occupants of the building, said weapon detector being electrically coupled to said control circuit, said control circuit receiving said alert input when said weapon detector detects a weapon;
a plurality of cameras, each of said cameras being coupled to said entry way wherein each of said cameras is configured to capture imagery of the people entering the building, each of said cameras being electrically coupled to said control circuit; and
a transceiver being integrated into the building, said transceiver being in communication with an extrinsic communication network wherein said transceiver is configured to be in communication with emergency responders, said transceiver broadcasting an alert signal when said weapon detector detects a weapon wherein said transceiver is configured to facilitate the emergency responders to respond to a potential shooter emergency at the building, said transceiver being electrically coupled to said control circuit, said transceiver broadcasting said alert signal when said control circuit receives said alert input, said transceiver broadcasting the image captured by said cameras pertaining to the person upon which the weapon was detected wherein said transceiver is configured to alert the emergency responders to the identity of the person upon which the weapon was detected.
